(19) United States
(12) Patent Application Publication
(10) Pub. No.: US 2011/0171333 A1
(43) Pub. Date: Jul. 14, 2011

(54) Morinda Citrifolia Based Antioxidant and Antimicrobial Formulations for Improved Color Stability and Increased Shelf Life of Various Meat Products

(76) Inventors: Bryant Wadsworth, Highland, UT (US); Richard Godbee, Saratoga Springs, UT (US); W. Nathan Tapp, Lubbock, TX (US); Janeal W.S. Yancey, Huntsville, AR (US); Jason K. Apple, Springdale, AR (US)

(21) Appl. No.: 12/945,586

(22) Filed: Nov. 12, 2010

Related U.S. Application Data
(63) Continuation-in-part of application No. 12/199,369, filed on Aug. 27, 2008.
Application No. 12/199,369 is a continuation-in-part of application No. 11/740,515, filed on Apr. 26, 2007.
Application No. 11/740,515 is a continuation of application No. 11/091,051, filed on Mar. 28, 2005, now abandoned.
Application No. 11/091,051 is a continuation-in-part of application No. 11/394,675, filed on Mar. 31, 2006, now abandoned.
Application No. 11/394,675 is a continuation-in-part of application No. 10/439,596, filed on May 16, 2003, now Pat. No. 7,048,952.
Application No. 10/439,596 is a continuation-in-part of application No. 11/562,224, filed on Nov. 21, 2006.
Application No. 11/562,224 is a continuation-in-part of application No. 11/360,550, filed on Feb. 23, 2006, now abandoned.
Application No. 11/360,550 is a division of application No. 10/285,359, filed on Oct. 31, 2002, now Pat. No. 7,033,624.
Application No. 10/285,359 is a continuation-in-part of application No. 10/006,014, filed on Dec. 4, 2001, now abandoned.
(60) Provisional application No. 61/260,912, filed on Nov. 13, 2009.
(60) Provisional application No. 60/970,445, filed on Sep. 6, 2007.
(60) Provisional application No. 60/740,593, filed on Nov. 29, 2005.
(60) Provisional application No. 60/335,343, filed on Nov. 2, 2001.
(60) Provisional application No. 60/251,416, filed on Dec. 5, 2000.

(51) Int. Cl. A01N 65/00; A01P 1/00; C11B 5/00; A23B 4/20

(52) U.S. Cl. 424/777; 424/725; 426/544; 426/652

(57) ABSTRACT

The present invention relates to Morinda citrifolia based formulations, which may be utilized as an organic antioxidant and antimicrobial agent to improve meat quality while avoiding exogenous food additives or packaging procedures. Moreover, the present invention relates to Morinda citrifolia based formulations, which may be utilized to promote enhancement in taste and appearance of meat products and improve color stability and increase shelf life of various meat products. Further the present invention relates to use of extracts or parts from the Morinda citrifolia plant in the manufacture of a formulations which may be utilized to promote enhancement in taste and appearance of meat products and improve color stability and increase shelf life of various meat products.

### CROSS-REFERENCE TO RELATED APPLICATIONS

This application claims priority to U.S. Provisional Patent Application Ser. No. 61/260,912 dated Nov. 13, 2009, entitled “MORINDA CITRIFOLIA BASED Antioxidant and Antimicrobial Formulations for Improved Color Stability and Increased Shelf Life of Various Meat Products”, is a continuation in part of U.S. patent Ser. No. 12/199,369 dated Aug. 27, 2008, entitled “Morinda Citrifolia Based Formulations for Regulating T cell Immunomodulation in Neonatal Stock Animals,” which claims priority to U.S. Provisional Patent Application No. 60/970,445, filed on Sep. 6, 2007, entitled, “Morinda Citrifolia Based Formulations for Regulating T Cell Immunomodulation in Neonatal Stock Animals,” and is a continuation in part of U.S. patent Ser. No. 11/740,515 dated Apr. 26, 2007, entitled “Morinda Citrifolia Based Antifungal Formulations and Methods,” which is a continuation of U.S. patent application Ser. No. 11/091,051, filed Mar. 28, 2005, entitled “Morinda Citrifolia Based Antifungal Formulations and Methods,” and is a continuation in part of U.S. patent Ser. No. 11/394,675 dated Mar. 31, 2006, entitled “Antifungal Effects Of Morinda Citrifolia,” and is a continuation in part of U.S. patent application Ser. No. 10/439,596, filed May 16, 2003, entitled, “Antifungal Effects of Morinda Citrifolia,” and claims priority to U.S. Provisional Application Ser. No. 60/382,246, filed May 21, 2002, entitled, “Antifungal Activity and Mean Inhibitory Concentration of Selected Extracts from Morinda citrifolia L. and related methods,” and is a continuation in part of U.S. patent Ser. No. 11/562,224 dated Nov. 21, 2006, entitled “Antiviral Morinda Citrifolia L. Based Formulations and Methods of Administration,” which claims priority to U.S. Provisional Application Ser. No. 60/740,593 filed Nov. 29, 2005, entitled “Antiviral Morinda Citrifolia L. Based Formulations and Methods for Administration” and is a continuation-in-part of U.S. patent application Ser. No. 11/360,550 filed Feb. 23, 2006, entitled “Preventative and Treatment Effects of Morinda Citrifolia on Osteoarthritis and Its Related Conditions” which is a divisional of U.S. patent application Ser. No. 10/285,359, now U.S. Pat. No. 7,033,624, filed Oct. 31, 2002, entitled “Preventative and Treatment Effects of Morinda Citrifolia on Osteoarthritis and Its Related Conditions” which claims priority to U.S. Provisional Patent Application No. 60/335,343 filed Nov. 2, 2001, entitled, “Methods for Treating Osteoarthritis” and is a continuation-in-part of U.S. patent application Ser. No. 10/006,014 filed Dec. 4, 2001, entitled “Tahitian Noni Juice On Cox-1 And Cox-2 And Tahitian Noni Juice As A Selective Cox-2 Inhibitor”, which claims priority to U.S. Provisional Patent Application Ser. No. 60/251,416 filed Dec. 5, 2000, entitled “Cox-1 and Cox-2 Inhibition Study on TNJ” each of which is hereby incorporated in its entirety herewith.

### FIELD OF THE INVENTION

The present invention relates to Morinda citrifolia based formulations, which may be utilized as an organic antioxidant and antimicrobial agent to improve meat quality, taste appearance and shelf life.

### BACKGROUND OF THE INVENTION

Prolonging the bright red color found on meat surfaces has been a major goal of the meat industry. The desirable red color of fresh package meat is due to the pigment oxymyoglobin. Oxymyoglobin is red. Oxymyoglobin is slowly oxidized to metamyoglobin in the presence of air to yield a superoxide radical anion. Metamyoglobin is brown. Prevention of this oxidation by any oxidants or by other means is thus important if the meat is to retain an appealing red color. Metamyoglobin may be oxidized to the strongly oxidizing species ferrylmyoglobin and perferrylmyogolbin. The kenetic competition between antioxidants and vulnerable lipids in reacting with these hypervalence meat pigments seems essential for protecting against oxidation of membering lipids. Maintenance of desirable, fresh meat is affected by many factors including the potential preserving effects of antioxidants in meat.

Oxidation of the muscle pigment oxymyoglobin to metmyoglobin leads to the discoloration of red meats. Further the process of oxymyoglobin and lipid oxidation in meat products are interrelated. Oxymyoglobin oxidation has been proposed as the first step in the sequence of reaction leading to the formation of a cation radical and ultimately to the initiation of the lipid oxidation.

Lipid peroxides are the primary products of lipid oxidation. Decomposition of lipid peroxides yields complex mixture of compounds with distinctive odor and flavor characteristics. Some of these compounds impart rancid, fatty, pungent, and other off flavored characteristics to meat. Flavor problems associated with lipid oxidations are particularly pronounced in cooked meats, particularly if meats are reheated. Higher quality “less processed” meats have higher levels of lipid oxidations than their more processed counterparts. Yet the former would be perceived by consumers as a healthier choice since they contain lower levels of additives.

Additionally, aspects of lipid oxidation products have received attention in scientific literature, and consumers are being made aware of the health implications of consuming oxidized lipids and their breakdown products. Oxidation products of cholesterol have been shown to be cytotoxic and mutagenic. LDL oxidation and cholesterol oxidation have been implicated in artherosclerosis. The first phase in a sequence of events that can lead to cardiac arrest or stroke. The evidence for an involvement of lipid oxidation and antioxidants in controlling the onset of a number of pathological conditions in humans and animals is convincing. The ability to retard oxidation of oxymyoglobin and to reduce ferrylmyoglobin and perferrylmyoglobin with the perspective of improving the color stability of meats and preventing pigment initiated lipid oxidation respectively is desirable.

### BRIEF SUMMARY

The present invention relates to Morinda citrifolia based formulations, which may be utilized as an organic antioxidant and antimicrobial agent to improve meat quality while avoiding exogenous food additives or packaging procedures. Moreover, the present invention relates to Morinda citrifolia based formulations, which may be utilized to promote enhancement in taste, appearance, improve color stability and increase shelf life of various meat products. Further the present invention relates to use of extracts or parts from the Morinda citrifolia plant in the manufacture of a formulations which may be utilized to promote enhancement in taste, appearance, improve color stability and increase shelf life of various meat products.

Implementation of the present invention takes place in association with the utilization of juice, puree, and other extracts or parts from the plant known as Morinda citrifolia L. The present invention provides various Morinda citrifolia based compositions, which may be comprised of extracts and/or processed products derived from the fruit, leaves, stem, seed bark and/or root of Morinda citrifolia. Further, embodiments of compositions may be utilized in combination with additional ingredients which may be utilized to improve the color stability and increase the shelf life of various meat products in association with the use of the described compositions.

The formulation also may comprise other natural ingredients. The present invention relates to use of extracts or parts from the Morinda citrifolia plant in the manufacture of a formulations which may be utilized in combination with additional ingredients to promote enhancement in taste and appearance of meat products and improve color stability and increase shelf life of various meat products. The Morinda citrifolia products are preferably supplied in a formulation designed to effect the inhibition of undesirable microbial activity.

### BRIEF DESCRIPTION OF THE DRAWINGS

In order that the matter in which the above-recited and other advantages of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a graphical representation of TBARS scores for meat treated with 0%, 2%, 4% and 6% Morinda citrifolia fruit puree over the course of a 5 day period;

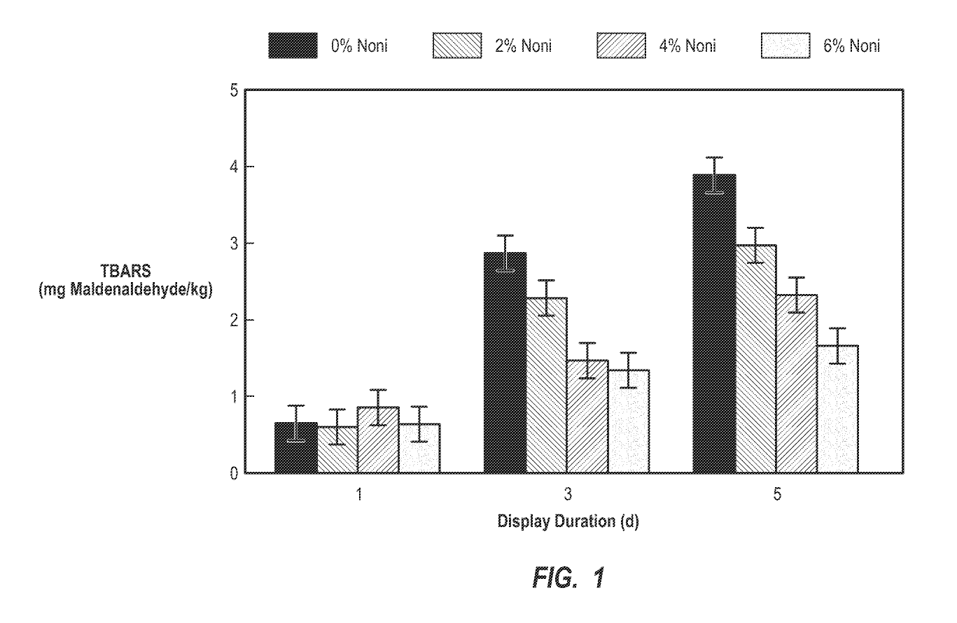

FIG. 2 is a graphical representation of the color score for discoloration of meat treated with various concentrations of Morinda citrifolia fruit puree over the course of a 5 day period;

FIG. 3 is a graphical representation of the worst point color score for meat treated with various concentrations of Morinda citrifolia fruit puree over the course of a 5 day period;

FIG. 4 is graphical representation of the total color score for meat treated with various concentrations of Morinda citrifolia fruit puree over the course of a 5 day period; and

FIG. 5 is graphical representation of the a-star color score for meat treated with various concentrations of Morinda citrifolia fruit puree over the course of a 5 day period.

### DETAILED DESCRIPTION

The compositions and formulations of the present invention, as generally described herein, may be designed to comprise variations. Thus, the following more detailed description of the embodiments of the formulations and methods of the present invention is not intended to limit the scope of the invention, as claimed, but is merely representative of the presently preferred embodiments of the invention.

In the disclosure and in the claims the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open—ended terms that do not exclude additional, unrecited elements or method steps. As used herein, the phrase “consisting of” and grammatical equivalents thereof exclude any element, step, or ingredient not specified in the claim. As used herein, an “effective amount” is an amount sufficient to effect beneficial or desired results. An effective amount can be administered in one or more administrations, applications or treatments. For example, an effective amount of a Morinda citrifolia based composition is an amount sufficient to provide antimicrobial activity, and antioxidant activity.

The following disclosure of the present invention is grouped into several subheadings. The utilization of the subheadings is for convenience of the reader only and is not to be construed as limiting in any sense.

General Description of the Morinda citrifolia L. Plant

The Indian Mulberry or Morinda citrifolia plant, known scientifically as Morinda Citrifolia L. (“Morinda citrifolia”), is a shrub or small tree up to 10 m in height. The leaves are oppositely arranged with an elliptic to ovate form. The small white flowers are contained in a fleshy, globose, head like cluster. The fruits are large, fleshy, and ovoid. At maturity, they are creamy white and edible, but have an unpleasant taste and odor. The plant is native to Southeast Asia and has spread in early times to a vast area from India to eastern Polynesia. It grows randomly in the wild, and it has been cultivated in plantations and small individual growing plots. The Morinda citrifolia flowers are small, white, three to five lobed, tubular, fragrant, and about 1.25 cm long. The flowers develop into compound fruits composed of many small drupes fused into an ovoid, ellipsoid or roundish, lumpy body, with waxy, white, or greenish-white or yellowish, semi-translucent skin. The fruit contains “eyes” on its surface, similar to a potato. The fruit is juicy, bitter, dull-yellow or yellowish-white, and contains numerous red-brown, hard, oblong-triangular, winged 2-celled stones, each containing four seeds. When fully ripe, the fruit has a pronounced odor like rancid cheese.

The Morinda citrifolia plant is rich in natural ingredients. Those ingredients that have been discovered include from the leaves: alanine, anthraquinones, arginine, ascorbic acid, aspartic acid, calcium, beta carotene, cysteine, cystine, glycine, glutamic acid, glycosides, histidine, iron, leucine, isoleucine, methionine, niacin, phenylalanine, phosphorus, proline, resins, riboflavin, serine, beta sitosterol, thiamine, threonine, tryptophan, tyrosine, ursolic acid, and valine; from the flowers: acacetin 7 o beta d (+) glucopyranoside, 5,7 dimethyl apigenin 4′ o beta d(+) galactopyranoside, and 6,8 dimethoxy 3 methylanthraquinone 1 o beta rhamnosyl glucopyranoside; from the fruit: acetic acid, asperuloside, butanoic acid, benzoic acid, benzyl alcohol, 1 butanol, caprylic acid, decanoic acid, (E) 6 dodeceno gamma lactone, (Z,Z,Z) 8,11,14 eicosatrienoic acid, elaidic acid, ethyl decanoate, ethyl hexanoate, ethyl octanoate, ethyl palmitate, (Z) 6 (ethylthiomethyl) benzene, eugenol, glucose, heptanoic acid, 2 heptanone, hexanal, hexanamide, hexanedioic acid, hexanoic acid (hexoic acid), 1 hexanol, 3 hydroxy 2 butanone, lauric acid, limonene, linoleic acid, 2 methylbutanoic acid, 3 methyl 2 buten 1 ol, 3 methyl 3 buten 1 ol, methyl decanoate, methyl elaidate, methyl hexanoate, methyl 3 methylthio propanoate, methyl octanoate, methyl oleate, methyl palmitate, 2 methylpropanoic acid, 3 methylthiopropanoic acid, myristic acid, nonanoic acid, octanoic acid (octoic acid), oleic acid, palmitic acid, potassium, scopoletin, undecanoic acid, (Z,Z) 2,5 undecadien 1 ol, and vomifol; from the roots: anthraquinones, asperuloside (rubichloric acid), damnacanthal, glycosides, morindadiol, morindine, morindone, mucilaginous matter, nor damnacanthal, rubiadin, rubiadin monomethyl ether, resins, soranjidiol, sterols, and trihydroxymethyl anthraquinone monomethyl ether; from the root bark: alizarin, chlororubin, glycosides (pentose, hexose), morindadiol, morindanigrine, morindine, morindone, resinous matter, rubiadin monomethyl ether, and soranjidiol; from the wood: anthragallol 2,3 dimethylether; from the tissue culture: damnacanthal, lucidin, lucidin 3 primeveroside, and morindone 6beta primeveroside; from the plant: alizarin, alizarin alpha methyl ether, anthraquinones, asperuloside, hexanoic acid, morindadiol, morindone, morindogenin, octanoic acid, and ursolic acid.

Processing Morinda citrifolia Leaves

The leaves of the Morinda citrifolia plant are one possible component of the Morinda citrifolia plant that may be present in some compositions of the present invention. For example, some compositions comprise leaf extract and/or leaf juice as described further herein. Some compositions comprise a leaf serum that is comprised of both leaf extract and fruit juice obtained from the Morinda citrifolia plant. Some compositions of the present invention comprise leaf serum and/or various leaf extracts as incorporated into a nutraceutical product (“nutraceutical” herein referring to any drug or product designed to improve the health of living organisms such as human beings or mammals).

In some embodiments of the present invention, the Morinda citrifolia leaf extracts are obtained using the following process. First, relatively dry leaves from the Morinda citrifolia L. plant are collected, cut into small pieces, and placed into a crushing device—preferably a hydraulic press—where the leaf pieces are crushed. In some embodiments, the crushed leaf pieces are then percolated with an alcohol such as ethanol, methanol, ethyl acetate, or other alcohol-based derivatives using methods known in the art. Next, in some embodiments, the alcohol and all alcohol-soluble ingredients are extracted from the crushed leaf pieces, leaving a leaf extract that is then reduced with heat to remove all the liquid there from. The resulting dry leaf extract will herein be referred to as the “primary leaf extract.”

In some embodiments of the present invention, the primary leaf extract is pasteurized to at least partially sterilize the extract and destroy objectionable organisms. The primary leaf extract is pasteurized preferably at a temperature ranging from 70 to 80 degrees Celsius and for a period of time sufficient to destroy any objectionable organisms without major chemical alteration of the extract. Pasteurization may also be accomplished according to various radiation techniques or methods.

In some embodiments of the present invention, the pasteurized primary leaf extract is placed into a centrifuge decanter where it is centrifuged to remove or separate any remaining leaf juice therein from other materials, including chlorophyll. Once the centrifuge cycle is completed, the leaf extract is in a relatively purified state. This purified leaf extract is then pasteurized again in a similar manner as discussed above to obtain a purified primary leaf extract.

Preferably, the primary leaf extract, whether pasteurized and/or purified, is further fractionated into two individual fractions: a dry hexane fraction, and an aqueous methanol fraction. This is accomplished preferably via a gas chromatograph containing silicon dioxide and CH2Cl2-MeOH ingredients using methods well known in the art. In some embodiments of the present invention, the methanol fraction is further fractionated to obtain secondary methanol fractions. In some embodiments, the hexane fraction is further fractionated to obtain secondary hexane fractions.

One or more of the leaf extracts, including the primary leaf extract, the hexane fraction, methanol fraction, or any of the secondary hexane or methanol fractions may be combined with the fruit juice of the fruit of the Morinda citrifolia plant to obtain a leaf serum (the process of obtaining the fruit juice to be described further herein). In some embodiments, the leaf serum is packaged and frozen ready for shipment; in others, it is further incorporated into a nutraceutical product as explained herein.

Processing Morinda citrifolia Fruit

Some embodiments of the present invention include a composition comprising fruit juice of the Morinda citrifolia plant. Processed Morinda citrifolia fruit juice can be prepared by separating seeds and peels from the juice and pulp of a ripened Morinda citrifolia fruit; filtering the pulp from the juice; and packaging the juice. Alternatively, rather than packaging the juice, the juice can be immediately included as an ingredient in another product, frozen or pasteurized. In some embodiments of the present invention, the juice and pulp can be pureed into a homogenous blend to be mixed with other ingredients. Other processes include freeze drying the fruit and juice. The fruit and juice can be reconstituted during production of the final juice product. Still other processes may include air drying the fruit and juices prior to being masticated.

In a currently preferred process of producing Morinda citrifolia fruit juice, the fruit is either handpicked or picked by mechanical equipment. The fruit can be harvested when it is at least one inch (2-3 cm) and up to 12 inches (24-36 cm) in diameter. The fruit preferably has a color ranging from a dark green through a yellow-green up to a white color, and gradations of color in between. The fruit is thoroughly cleaned after harvesting and before any processing occurs.

The fruit is allowed to ripen or age from 0 to 14 days, but preferably for 2 to 3 days. The fruit is ripened or aged by being placed on equipment so that the fruit does not contact the ground. The fruit is preferably covered with a cloth or netting material during aging, but the fruit can be aged without being covered. When ready for further processing the fruit is light in color, such as a light green, light yellow, white or translucent color. The fruit is inspected for spoilage or for excessive green color and firmness. Spoiled and hard green fruit is separated from the acceptable fruit.

The ripened and aged fruit is preferably placed in plastic lined containers for further processing and transport. The containers of aged fruit can be held from 0 to 30 days, but preferably the fruit containers are held for 7 to 14 days before processing. The containers can optionally be stored under refrigerated conditions prior to further processing. The fruit is unpacked from the storage containers and is processed through a manual or mechanical separator. The seeds and peel may be separated from the juice and pulp.

The juice and pulp can be packaged into containers for storage and transport. Alternatively, the juice and pulp can be immediately processed into a finished juice product. The containers can be stored in refrigerated, frozen, or room temperature conditions. The Morinda citrifolia juice and pulp are preferably blended in a homogenous blend, after which they may be mixed with other ingredients, such as flavorings, sweeteners, nutritional ingredients, botanicals, and colorings. The finished juice product is preferably heated and pasteurized at a minimum temperature of 181° F. (83° C.) or higher up to 212° F. (100° C.). Another product manufactured is Morinda citrifolia puree and puree juice, in either concentrate or diluted form. Puree is essentially the pulp separated from the seeds and is different than the fruit juice product described herein.

The product is filled and sealed into a final container of plastic, glass, or another suitable material that can withstand the processing temperatures. The containers are maintained at the filling temperature or may be cooled rapidly and then placed in a shipping container. The shipping containers are preferably wrapped with a material and in a manner to maintain or control the temperature of the product in the final containers.

The juice and pulp may be further processed by separating the pulp from the juice through filtering equipment. The filtering equipment preferably consists of, but is not limited to, a centrifuge decanter, a screen filter with a size from 1 micron up to 2000 microns, more preferably less than 500 microns, a filter press, a reverse osmosis filtration device, and any other standard commercial filtration devices. The operating filter pressure preferably ranges from 0.1 psig up to about 1000 psig. The flow rate preferably ranges from 0.1 g.p.m. up to 1000 g.p.m., and more preferably between 5 and 50 g.p.m. The wet pulp is washed and filtered at least once and up to 10 times to remove any juice from the pulp. The resulting pulp extract typically has a fiber content of 10 to 40 percent by weight. The resulting pulp extract is preferably pasteurized at a temperature of 181° F. (83° C.) minimum and then packed in drums for further processing or made into a high fiber product.

Processing Morinda citrifolia Seeds

Some Morinda citrifolia compositions of the present invention include seeds from the Morinda citrifolia plant. In some embodiments of the present invention, Morinda citrifolia seeds are processed by pulverizing them into a seed powder in a laboratory mill. In some embodiments, the seed powder is left untreated. In some embodiments, the seed powder is further defatted by soaking and stirring the powder in hexane—preferably for 1 hour at room temperature (Drug:Hexane—Ratio 1:10). The residue, in some embodiments, is then filtered under vacuum, defatted again (preferably for 30 minutes under the same conditions), and filtered under vacuum again. The powder may be kept overnight in a fume hood in order to remove the residual hexane.

Still further, in some embodiments of the present invention, the defatted and/or untreated powder is extracted, preferably with ethanol 50% (m/m) for 24 hours at room temperature at a drug solvent ratio of 1:2.

Processing Morinda citrifolia Oil

Some embodiments of the present invention may comprise oil extracted from the Morinda Citrifolia plant. The method for extracting and processing the oil is described in U.S. patent application Ser. No. 09/384,785, filed on Aug. 27, 1999 and issued as U.S. Pat. No. 6,214,351 on Apr. 10, 2001, the entirety of which is incorporated by reference herein. The Morinda citrifolia oil typically includes a mixture of several different fatty acids as triglycerides, such as palmitic, stearic, oleic, and linoleic fatty acids, and other fatty acids present in lesser quantities. In addition, the oil preferably includes an antioxidant to inhibit spoilage of the oil. Conventional food grade antioxidants are preferably used.

### Formulations

The following section details some preferred embodiments of Morinda citrifolia -based formulations and methods of utilizes which may be utilized as an organic agent to improve meat quality, taste, appearance and shelf life. The present invention advances antimicrobial inhibitors and antioxidants by providing a composition formulated with one or more processed Morinda citrifolia products derived from the Indian Mulberry plant. The Morinda citrifolia is incorporated into various carriers or compositions suitable for use in association with consumable goods including various meat products.

Compositions of the present invention may comprise any of a number of Morinda citrifolia components such as: leaf extract, leaf juice, leaf serum, fruit juice, fruit pulp, pulp extract, puree, seeds (whether defatted or untreated), and oil. Compositions of the present invention may also include various other ingredients. Examples of other ingredients include, but are not limited to: artificial flavoring, other natural juices or juice concentrates such as a natural grape juice concentrate or a natural blueberry juice concentrate; carrier ingredients; and others as will be further explained herein.

Any compositions having the leaf extract from the Morinda citrifolia leaves, may comprise one or more of the following: the primary leaf extract, the hexane fraction, methanol fraction, the secondary hexane and methanol fractions, the leaf serum, or the nutraceutical leaf product.

In some embodiments of the present invention, active ingredients or compounds of Morinda citrifolia components may be extracted out using various procedures and processes. For instance, the active ingredients may be isolated and extracted out using alcohol or alcohol-based solutions, such as methanol, ethanol, and ethyl acetate, and other alcohol-based derivatives using methods known in the art. These active ingredients or compounds may be isolated and further fractioned or separated from one another into their constituent parts. Preferably, the compounds are separated or fractioned to identify and isolate any active ingredients that might help to prevent disease, enhance health, or perform other similar functions. In addition, the compounds may be fractioned or separated into their constituent parts to identify and isolate any critical or dependent interactions that might provide the same health-benefiting functions just mentioned. Quercetin and Rutin are non-limiting examples of active ingredients that may be isolated. For example, an active ingredient, including Quercetin and Rutin, may be present in amounts by weight ranging from 0.01-10 percent of the total formulation or composition. These amounts may be concentrated as well into a more potent concentration in which they are present in amounts ranging from 10 to 100 percent.

Formulations of the present invention may be applied to various meat products and other consumable goods at various stages as the consumable goods are being processed and packaged. In fact, the following usage may be suggested: the formulation may be mixed with consumable goods prior to packaging; dispersed on the consumable product during processing; dispersed or mixed with the consumable product before processing; and dispersed or mixed with the consumable product before processing and prior to packaging.

In one exemplary embodiment, the composition of the present invention comprises one or more of a processed Morinda citrifolia (e.g. Morinda citrifolia fruit juice or fruit juice or puree juice) product present in an amount by weight between about 0.01 and 100 percent by weight, and preferably between 0.01 and 95 percent by weight. Several embodiments of formulations are provided below. However, these are only intended to be exemplary as other formulations or compositions comprising the processed Morinda citrifolia product are contemplated.

The processed Morinda citrifolia product may comprise at least one of the active ingredient, such as Quercetin and rutin, and others, for effectuating antioxidant activity and/or the inhibition of microbial activity.

Active ingredients within the processed Morinda citrifolia product may be extracted out using various alcohol or alcohol-based solutions, such as methanol, ethanol, and ethyl acetate, and other alcohol-based derivatives using procedures and processes commonly known in the art. In some embodiments the active ingredients of scopoletin, quercetin and rutin may be present in amounts by weight ranging from 0.01-10 percent of the total formulation or composition. If desired, these amounts may be concentrated into a more potent concentration in which they are present in amounts ranging from 10 to 100 percent.

In one exemplary embodiment, the method comprises the steps of (a) formulating a composition comprising in part a processed Morinda citrifolia product present in an amount between about 0.01 and 95 percent by weight, wherein the composition may also comprises a carrier, such as water or purified water, and may also comprise other natural ingredients; (b) applying and/or mixing the composition to the desired consumable good, such that the processed Morinda citrifolia product is allowed to be incorporated or come into contact with the consumable good; (c) repeating the above steps as often as necessary to provide an effective amount of the processed Morinda citrifolia product needed to promote enhancement in taste, improve appearance, improve color stability and/or increase shelf life of the consumable good, for example a meat product. The amount of composition and frequency of use may vary from consumable good to the next.

In one exemplary embodiment, a Morinda citrifolia composition of the present invention comprises one or more of a processed Morinda citrifolia component present in an amount by weight between about 0.01 and 100 percent by weight, and preferably between 0.01 and 95 percent by weight.

In another exemplary embodiment, the internal composition comprises the ingredients of: processed Morinda citrifolia fruit juice or puree juice present in an amount by weight between about 0.1-80 percent; processed Morinda citrifolia oil present in an amount by weight between about 0.1-20 percent; and a carrier medium present in an amount by weight between about 20-90 percent. Morinda citrifolia puree juice or fruit juice may also be formulated with a processed Morinda citrifolia dietary fiber product present in similar concentrations.

The following tables illustrate or represent some of the preferred formulations or compositions contemplated by the present invention. As stated, these are only intended as exemplary embodiments and are not to be construed as limiting in any way.

### Formulation One

| Ingredients | Percent by Weight |
|---|---|
| Morinda citrifolia puree juice or fruit juice | 100% |

### Formulation Two

| Ingredients | Percent by Weight |
|---|---|
| Morinda citrifolia puree or fruit juice | 85-99.99% |
| Water | 0.01-15% |

### Formulation Three

| Ingredients | Percent by Weight |
|---|---|
| Morinda citrifolia puree or fruit juice | 0.01-15% |
| Water | 85-99.99% |

### Formulation Four

| Ingredients | Percent by Weight |
|---|---|
| Morinda citrifolia puree or fruit juice | 15-85% |
| Water | 15-85% |

### Formulation Five

| Ingredients | Percent by Weight |
|---|---|
| Morinda citrifolia puree or fruit juice | 20-90.8% |
| Water | 0.1-50% |
| Additional Ingredients | 0.1-30% |

### Formulation Six

| Ingredients | Percent by Weight |
|---|---|
| Morinda citrifolia puree or fruit juice | 0.1-30% |
| Water | 0.1-50% |
| Additional Ingredients | 20-90.8% |

### Formulation Seven

| Ingredients | Percent by Weight |
|---|---|
| Extracted Ingredient from Morinda citrifolia | 100% |
| fruit, pericarp, stem, seed and/or root | |

### Formulation Eight

| | |
|---|---|
| Ingredients | Percent by Weight |

| | |
|---|---|
| Extracted Ingredient from Morinda citrifolia | 85-99.99% |
| fruit, pericarp, stem, seed and/or root | |
| Water | 0.01-15% |

### Formulation Nine

| | |
|---|---|
| Ingredients | Percent by Weight |

| | |
|---|---|
| Extracted Ingredient from Morinda citrifolia | 0.01-15% |
| fruit, pericarp, stem, seed and/or root | |
| Water | 85-99.99% |

### Formulation Ten

| | |
|---|---|
| Ingredients | Percent by Weight |

| | |
|---|---|
| Extracted Ingredient from Morinda citrifolia | 50-90.98% |
| fruit, pericarp, stem, seed and/or root | |
| Water | 0.01-50% |
| Other active ingredient | 0.01-30% |

### Formulation Eleven

| | |
|---|---|
| Ingredients | Percent by Weight |

| | |
|---|---|
| Extracted Ingredient from Morinda citrifolia | 0.1-30% |
| fruit, pericarp stem, seed and/or root | |
| Water | 1-99.9% |
| Additional ingredient(s) | 1-99.9% |

### Formulation Twelve

| Ingredients | Percent by Weight |
|---|---|
| Morinda citrifolia oil | 0.1-30% |
| Carrier medium | 70-99.9% |
| Other ingredients | 1-95% |

### Formulation Thirteen

| Ingredients | Percent by Weight |
|---|---|
| Morinda citrifolia product | 10-80% |
| Carrier medium | 20-90% |

### Formulation Fourteen

| Ingredients | Percent by Weight |
|---|---|
| Morinda citrifolia product | 5-80% |
| Carrier medium | 20-95% |

### Formulation Fifteen

| Ingredients | Percent by Weight |
|---|---|
| Morinda citrifolia oil or oil extract | 0.1-20% |
| Carrier medium | 20-90% |

### Formulation Sixteen

| Ingredients | Percent by Weight |
|---|---|
| Morinda citrifolia puree juice or fruit juice | 0.1-80% |
| Morinda citrifolia oil | 0.1-20% |
| Carrier medium | 20-90% |

### Formulation Seventeen

| Ingredients | Percent by Weight |
|---|---|
| Morinda citrifolia puree juice concentrate | 100% |
| or fruit juice concentrate | |

### Formulation Eighteen

| Ingredients | Percent by Weight |
|---|---|
| Morinda citrifolia fruit juice concentrate | 85-99.99% |
| or puree juice concentrate | |
| Water | 0.1-15% |

### Formulation Nineteen

| Ingredients | Percent by Weight |
|---|---|
| Morinda citrifolia puree juice or fruit juice fraction | 100% |

### Formulation Twenty

| Ingredients | Percent by Weight |
|---|---|
| Morinda citrifolia fruit juice fraction | 85-99.99% |
| Water | 0.1-15% |

### Formulation Twenty One

| Ingredients | Percent by Weight |
|---|---|
| Morinda citrifolia fruit juice fraction | 85-99.99% |
| Other active ingredient | 0.1-15% |

### Formulation Twenty Two

| Ingredients | Percent by Weight |
|---|---|
| Morinda citrifolia fruit juice fraction | 50-90% |
| Water | 0.1-50% |
| Other active ingredient | 0.1-30% |

### Formulation Twenty Three

| Ingredients | Percent by Weight |
|---|---|
| Morinda citrifolia puree juice fraction | 85-99.9% |
| Water | 0.1-15% |

### Formulation Twenty Four

| Ingredients | Percent by Weight |
|---|---|
| Morinda citrifolia juice | 0.1-80% |
| Extracted ingredient(s) from Morinda citrifolia | 0.1-20% |
| Other active ingredient | 20-90% |

In one example, which is not meant to be limiting in any way, the beneficial Morinda citrifolia is processed into TAHITIAN NONI ® juice manufactured by Tahitan Noni International, Inc. In any embodiment, the processed Morinda citrifolia product may comprise one or more of a processed Morinda citrifolia fruit juice, processed Morinda citrifolia puree juice, processed Morinda citrifolia fruit or puree juice concentrate, extracted ingredient(s) from Morinda citrifolia, and/or processed Morinda citrifolia oil extract product.

The carrier medium identified in the above-identified Formulations may comprise any ingredient capable of being introduced into or onto the consumable goods, and that is also capable of providing the carrying medium to the processed Morinda citrifolia product. The purpose of the carrier medium is as stated, to provide a means to embody the processed Morinda citrifolia product within the formulation that is capable of being introduced into or onto the desired consumable good.

### Antimicrobial Activity

The following examples set forth and present the preventative and treatment effects of the processed Morinda citrifolia products on fungal activity. These examples are not intended to be limiting in any way, but are merely illustrative of the benefits and advantageous of the Morinda citrifolia products.

Studies were performed to determine the mean inhibitory concentrations of certain extracts from Morinda citrifolia against activity of common fungi and bacteria. The antimicrobial activity of Morinda citrifolia based products is described in U.S. patent Ser. No. 11/740,515 dated Apr. 26, 2007, entitled “Morinda Citrifolia Based Antifungal Formulations and Methods,” U.S. patent application Ser. No. 11/091,051, filed Mar. 28, 2005, entitled “Morinda Citrifolia Based Antifungal Formulations and Methods,” U.S. patent Ser. No. 11/394,675 dated Mar. 31, 2006, entitled “Antifungal Effects Of Morinda Citrifolia,” U.S. patent application Ser. No. 10/439,596, filed May 16, 2003, entitled, “Antifungal Effects of Morinda Citrifolia,” and in U.S. Provisional Application Ser. No. 60/382,246, filed May 21, 2002, entitled, “Antifungal Activity and Mean Inhibitory Concentration of Selected Extracts from Morinda citrifolia L. and related methods,” the entirety of which are incorporated by reference herein. The studies demonstrated that extracts of Morinda citrifolia were found to exhibit antimicrobial activity when tested against common bacteria and fungi, including E. coli.

The results of the test showed that activity of ethanol extracts ranged from <6.3 μl to 200 μl; the activity of methanol extracts ranged from <6.3 μl to 200 μl; the activity of ethyl acetate extracts ranged from 50 μl to 200 μl; and that ethanol and methanol extracts were the most effective against all of the microorganisms tested. Results indicate that the ethanol and methanol Morinda citrifolia extracts had meaningful activity against all of the microorganisms tested. Preliminary drying studies indicated that the activity using the ethanol and methanol extracts was in the 5-10 mg/ml range. Ethyl acetate extracts contained <10% of the amount found in the ethanol and methanol extracts. From this series of studies, it can clearly be established that Morinda citrifolia fruit or the extracts thereof exhibit antimicrobial activity.

Included in the studies performed were minimum inhibitory concentration and minimum lethal concentration assays, which are detailed herein. The minimum inhibitory concentration (MIC) of an antibacterial is defined as the maximum dilution of the product that will still inhibit the growth of a test microorganism. The minimum lethal concentration (MLC) of an antibacterial is defined as the maximum dilution of the product that killed a test organism. MIC/MLC values can be determined by a number of standard test procedures. The most commonly employed methods are the tube dilution method and agar dilution methods. The tube dilution method was proposed for this product to determine the MIC, and plating aliquots from dilutions demonstrating possible inhibition of growth to determine the MLC. Serial dilutions were made of the products in bacterial growth media. The test organisms were added to the dilutions of the products, incubated, and scored for growth. All tests were performed in triplicate.

With the exception of S. mutans, all organisms were inhibited by neutralized Morinda citrifolia concentrate at a 1:2 concentration. The MIC results for all organisms are summarized in Tables 1-7. The MLC results for each organism are summarized in Tables 8-14. Since S. mutans did not have any dilutions that were scored as having no growth for the MIC portion of the test, MLC was not performed for this organism.

The neutralization recoveries for all test organisms ranged from 40-97%. The neutralization recovery of the neutralizing media used in the study is summarized in Table 14.

TABLE 1
Mean Inhibitory Concentration Results for
Escherichia coli O157H7 ATCC #43885

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 7.0×10⁸ CFU/mL
Inoculating volume=0.05 mL

TABLE 2
Mean Inhibitory Concentration Results
for Staphylococcus aureus ATCC #6538

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 6.5×10⁸ CFU/mL
Inoculating volume=0.05 mL

TABLE 3
Mean Inhibitory Concentration Results
for Bacillus subtilis ATCC #19659

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 8.5×10⁷ CFU/mL
Inoculating volume=0.05 mL

TABLE 4
Mean Inhibitory Concentration Results for Salmonella choleraesuis
serotype enteritidis ATCC #13706

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| Positive | + | + | + |
| Negative | 0 | 0 | 0 |
| Media | 0 | 0 | 0 |

Titer: 4.8×10⁸ CFU/mL
Inoculating volume=0.05 mL

TABLE 5
Mean Inhibitory Concentration Results for
Listeria monocytogenes ATCC #19111

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 3.9×10⁸ CFU/mL
Inoculating volume=0.05 mL

TABLE 6
Mean Inhibitory Concentration Results
for Candida albicans ATCC #10231

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 1.3×10⁸ CFU/mL
Inoculating volume=0.05 mL

TABLE 7
Mean Inhibitory Concentration Results
for Streptococcus mutans ATCC #25l75

| DILUTION | GROWTH +/0 | | |
|---|---|---|---|
| 1:2 | + | + | + |
| 1:4 | + | + | + |
| 1:8 | + | + | + |
| Positive | + | + | + |
| Negative | 0 | 0 | 0 |
| Media | 0 | 0 | 0 |

Titer: 1.0×10⁷ CFU/mL
Inoculating volume=0.05 mL

TABLE 8
Mean Lethal Concentration Results for
Escherichia coli 0157H7 ATCC #43588

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 245 |
| | 2 | TNTC | TNTC | TNTC | 239 |
| | 3 | TNTC | TNTC | TNTC | 215 |

Volume plated=0.5 mL
TNTC=Too Numerous To Count

TABLE 9
Mean Lethal Concentration Results for
Staphylococcus aureus ATCC #6538

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 200 |
| | 2 | TNTC | TNTC | TNTC | 134 |
| | 3 | TNTC | TNTC | TNTC | 114 |

Volume plated=0.5 mL
TNTC=Too Numerous To Count

TABLE 10
Mean Lethal Concentration Results for
Bacillus subtilis ATCC #19659

DILUTION

| DILUTION | REPLICATE | 10⁰ | 10⁻¹ | 10⁻² | 10⁻³ |
|---|---|---|---|---|---|
| 1:2 | 1 | 27 | 3 | 0 | 0 |
| | 2 | 25 | 2 | 0 | 0 |
| | 3 | 18 | 2 | 0 | 0 |

Volume plated=0.5 mL

TABLE 11
Mean Lethal Concentration Results for Salmonella choleraesuis
serotype enteritidis ATCC #13706

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | 41 | 7 |
| | 2 | TNTC | TNTC | 75 | 5 |
| | 3 | TNTC | TNTC | 63 | 6 |

Volume plated=0.5 mL
TNTC=Too Numerous To Count

TABLE 12
Mean Lethal Concentration Results for
Listeria monocytogenes ATCC #19111

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 109 |
| | 2 | TNTC | TNTC | TNTC | 109 |
| | 3 | TNTC | TNTC | TNTC | 179 |

Volume plated=0.5 mL
TNTC=Too Numerous To Count

TABLE 13
Mean Lethal Concentration Results
for Candida albicans ATCC #10231

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 168 |
| | 2 | TNTC | TNTC | TNTC | 117 |
| | 3 | TNTC | TNTC | TNTC | 138 |

Note: Volume plated=0.5 mL
TNTC=Too Numerous To Count

TABLE 14
Neutralization

| | | | | | NEUTRALIZATION | | | | |
|---|---|---|---|---|---|---|---|---|---|
| | POSITIVE COUNT | | | | COUNT | | | | PERCENT |
| ORGANISM | 1 | 2 | 3 | AVE | 1 | 2 | 3 | AVE | RECOVERY |
| E. coli 0157H7 | 60 | 63 | 58 | 60 | 53 | 50 | 73 | 59 | 97% |
| S aureus | 48 | 65 | 38 | 50 | 49 | 44 | 42 | 45 | 89% |
| B. subtilis | 53 | 61 | 53 | 56 | 25 | 20 | 22 | 22 | 40% |
| S. choleraesuis | 38 | 43 | 36 | 39 | 34 | 34 | 31 | 33 | 85% |
| L. monocytogenes | 43 | 38 | 22 | 34 | 26 | 31 | 34 | 30 | 88% |
| C. albicans | 36 | 25 | 21 | 27 | 20 | 12 | 27 | 20 | 72% |
| S. mutans | 11 | 19 | 13 | 14 | 9 | 16 | 14 | 13 | 91% |

### Antioxidant Activity

Visual appraisals of meat color are closely related to consumer evaluations. Improving the visual of appearance of meat color has an effect of hedonic scales including desirability and acceptability of the meat products to consumers. The color of fresh packaged meat results at least in part from the relative proportions of oxymyoglobin and metabmyglobin at the meat surface. This distrubtion depends on a dynamic state in which oxidation of oxy-to met-and the reduction of met-to oxy-are active can currently in process. A substance that delays oxidation of oxymyoglobin, or enhances reduction of metamyoglobin will help to prolong the desirable appearance of fresh meat.

The antioxidant activity of Morinda citrifolia based products is described in U.S. patent application Ser. Nos. 11/741,169 and 09/997,588, the entirety of both applications is incorporated by reference herein. The studies were designed to measure how well processed Morinda citrifolia products scavenged superoxide anion radicals (SAR) and quenched lipid peroxides (LPO) by TNB assay and LMB assay, respectively. In vitro processed Morinda citrifolia products showed a dose-dependent inhibition of both LPO and SAR. The SAR scavenging activity of processed Morinda citrifolia products was compared to that of three known antioxidants: Vitamin C, grape seed powder, and Pycnogenol. Under the experimental conditions, the SAR scavenging activity of processed Morinda citrifolia products was shown to be 2.8 times that of vitamin C, 1.4 times that of Pycnogenol, and 1.1 times that of grape seed powder. Processed Morinda citrifolia products showed significant potential to scavenge reactive oxygen free radicals.

Additional research was performed to ascertain the effects of using Morinda citrifolia fruit pulp on beef patties to enhance color stability. Course ground beef (85% lean) from a commercial processor was mixed with Morinda citrifolia fruit pulp at 0, 2, 4, or 6%, ground through a 9.5 mm plate, and formed into 113 gram patties. Patties were packaged on foam trays with overwrap and placed in simulated retail display for instrumental and visual color on days 1-5, and Thiobarbituric Acid Reactive Substances (TBARS) on days 0, 3, and 5. Plasma concentrations of thiobarbituric acid reactive substances (TBARS) are an index of lipid peroxidation and oxidative stress. Changes in color were determined by measuring Commission Internationale de l'Eclairage (CIE) L* (lightness), a* (redness) and b* (yellowness) color variables.

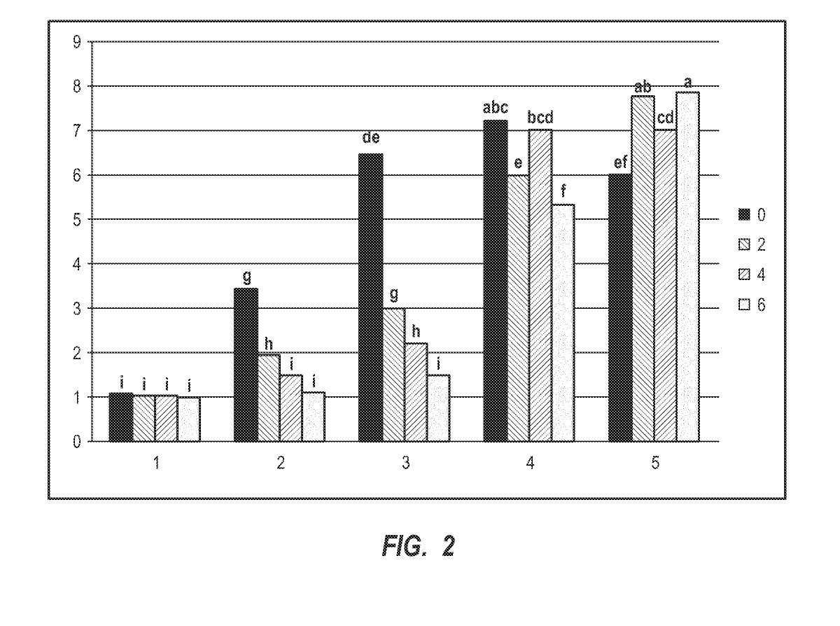

Table 15 illustrates data acquired in the TBARS assay on days 1-5 for meat products treated with between 0 and 6% Morinda citrifolia fruit Puree, particularly disclosing discoloration scores. The data set forth in Table 15 corresponds with FIG. 2. Meat treated with higher concentrations of Morinda citrifolia fruit Puree demonstrates superior resistance to discoloration over the extended 5 day period time of shelf life.

TABLE 15
Discoloration

| Noni | 1 | 2 | 3 | 4 | 5 |
|---|---|---|---|---|---|
| 0 | 1.15 | 3.4727 | 6.4727 | 7.2444 | 6 |
| 2 | 1.0667 | 2.0182 | 2.9818 | 6.0222 | 7.769 |
| 4 | 1.0833 | 1.5091 | 2.2545 | 7 | 6.9868 |
| 6 | 1.05 | 1.1624 | 1.5091 | 5.345 | 7.833 |

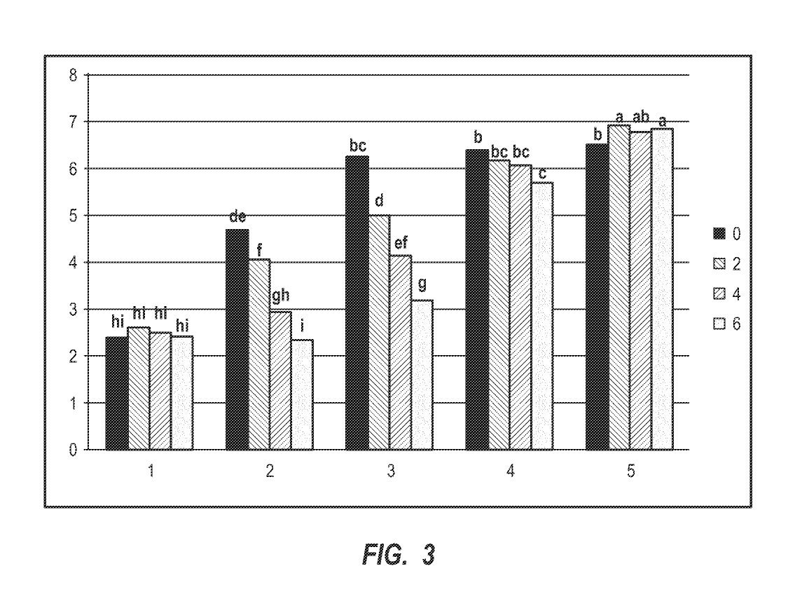

Table 16 illustrates data acquired from TBARS assay on days 1-5 for meat products treated with between 0 and 6% Morinda citrifolia fruit puree, particularly disclosing worst point scores. The data set forth in Table 16 corresponds with FIG. 3. Meat treated with higher concentrations of Morinda citrifolia fruit Puree demonstrates superior worst point scores over the extended 5 day period time of shelf life.

TABLE 16
Worst Point Scores

| Noni | 1 | 2 | 3 | 4 | 5 |
|---|---|---|---|---|---|
| 0 | 2.45 | 4.7273 | 6.2545 | 6.4 | 6.5 |
| 2 | 2.6333 | 4.07237 | 5 | 6.1778 | 6.9217 |
| 4 | 2.5667 | 3.0182 | 4.2727 | 6.0889 | 6.7497 |
| 6 | 2.45 | 2.3817 | 3.2182 | 5.684 | 6.8266 |

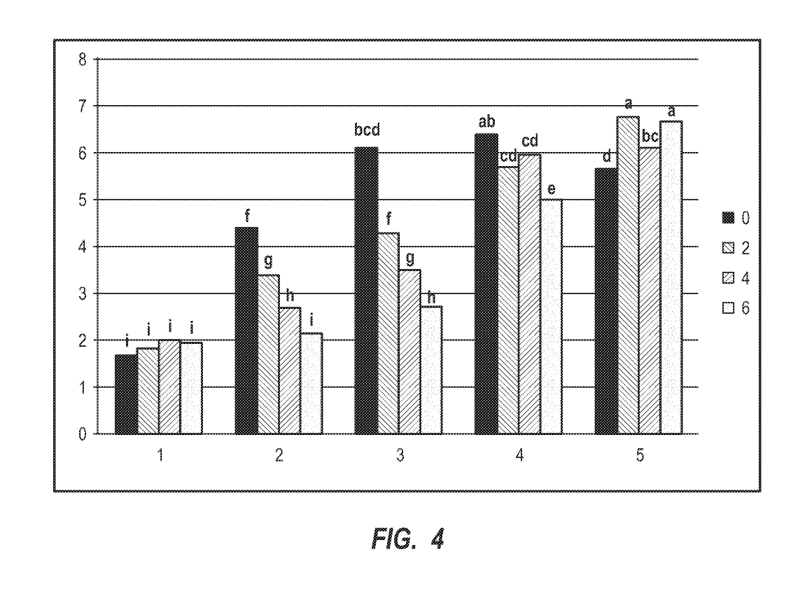

Table 17 illustrates data acquired in a TBARS assay on days 1-5 for meat products treated with between 0 and 6% Morinda citrifolia fruit puree, particularly disclosing the total color scores acquired. The data set forth in Table 17 corresponds with FIG. 4. Meat treated with higher concentrations of Morinda citrifolia fruit Puree demonstrates superior total color scores over the extended 5 day period time of shelf life.

TABLE 17
Total Color

| Noni | 1 | 2 | 3 | 4 | 5 |
|---|---|---|---|---|---|
| 0 | 1.6667 | 4.3818 | 6.0818 | 6.3889 | 5.65 |
| 2 | 1.7833 | 3.3636 | 4.2455 | 5.6889 | 6.7499 |
| 4 | 1.9833 | 2.6545 | 3.4909 | 5.9556 | 6.0822 |
| 6 | 1.9333 | 2.1212 | 2.6545 | 4.9949 | 6.6207 |

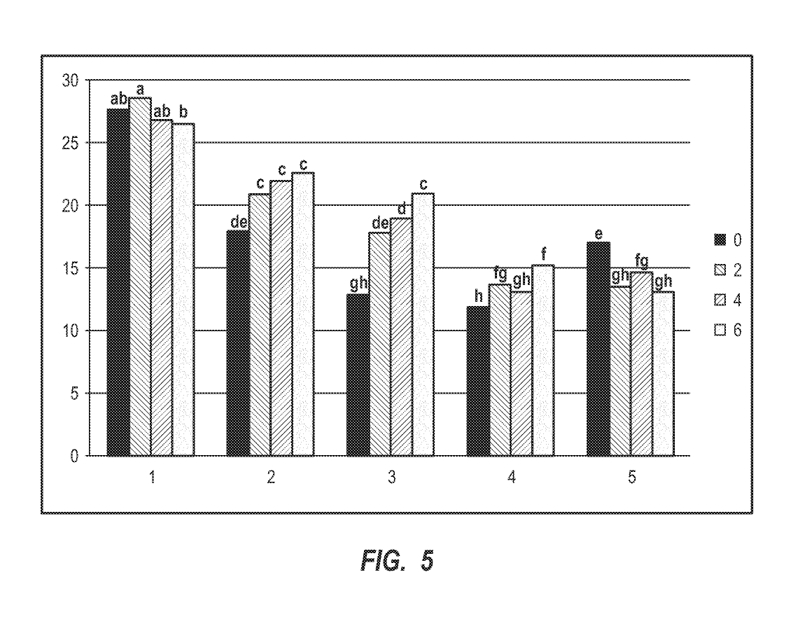

Table 18 illustrates data acquired in a TBARS assay on days 1-5 for meat products treated with between 0 and 6% Morinda citrifolia fruit puree, particularly disclosing the a-star scores acquired. The data set forth in Table 18 corresponds with FIG. 5. Meat treated with higher concentrations of Morinda citrifolia fruit Puree demonstrates superior resistance to discoloration over the extended 5 day period time of shelf life.

TABLE 18
a-star

| % Noni | Day 1 | Day 2 | Day 3 | Day 4 | Day 5 |
|---|---|---|---|---|---|
| 0 | 27.458 | 17.8033 | 12.7607 | 11.802 | 16.8907 |
| 2 | 28.2127 | 20.7153 | 17.6 | 13.568 | 13.386 |
| 4 | 26.53 | 21.8307 | 18.718 | 13.3367 | 14.398 |
| 6 | 26.254 | 22.3473 | 20.694 | 15.1527 | 12.9213 |

Although total sensory color score rose as display duration increased; until day 5, treatments with greater concentrations of Morinda citrifolia showed an improved (P<0.05) color score. Results showed an increase in worst point color scores with display duration, and before day 4, higher levels of Morinda citrifolia resulted in lower (P<0.05) worst point values. Similarly, percent discoloration increased with display duration, and until day 4, higher concentrations of Morinda citrifolia resulted in lower (P<0.05) percent discoloration values. While measuring redness, a* decreased with display duration, and higher a* values were generally associated with an increased concentration of Morinda citrifolia. Results showed that an increase in display duration increased (P<0.05) rancidity (TBARS), while higher levels of Morinda citrifolia decreased (P<0.05) rancidity. These findings support the notion that Morinda citrifolia pulp is beneficial in extending the fresh apparel of ground beef products over longer shelf life periods.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. An organic antioxidant formulation comprising:
at least one processed Morinda citrifolia product present in an amount between about 0.01 and 99.99 percent by weight of the formulation.

2. The formulation of claim 1, comprising an additional ingredient present in an amount between about 0.01 and 10 percent by weight of the formulation.

3. The formulation of claim 1, wherein said Morinda citrifolia product comprises one or more of the following: Morinda citrifolia fruit juice, Morinda citrifolia oil extract, Morinda citrifolia dietary fiber, Morinda citrifolia puree juice, Morinda citrifolia puree, Morinda citrifolia fruit juice concentrate, Morinda citrifolia puree juice concentrate.

4. The formulation of claim 1, further comprising at least one of quercetin and rutin.

5. The formulation of claim 4, wherein said one of quercetin and rutin is present in an amount between 0.01 and 10% by weight.

6. An organic antimicrobial formulation comprising:
at least one processed Morinda citrifolia product present in an amount between about 0.01 and 99.99 percent by weight of the formulation.

7. The formulation of claim 6, comprising an additional ingredient present in an amount between about 0.01 and 10 percent by weight of the formulation.

8. The formulation of claim 6, wherein said Morinda citrifolia product is comprised of one or more of the following: Morinda citrifolia fruit juice, Morinda citrifolia oil extract, Morinda citrifolia dietary fiber, Morinda citrifolia puree juice, Morinda citrifolia puree, Morinda citrifolia fruit juice concentrate, Morinda citrifolia puree juice concentrate.

9. The formulation of claim 6, further comprising at least one of quercetin and rutin.

10. The formulation of claim 9, wherein said at least one of quercetin and rutin is present in an amount between 0.01 and 10% by weight.

11. A Morinda citrifolia based formulations, which may be utilized to improve color stability various meat products comprising:
at least one processed Morinda citrifolia product present in an amount between about 0.01 and 99.99 percent by weight of the formulation.

12. The formulation of claim 11, comprising an additional ingredient present in an amount between about 0.01 and 10 percent by weight of the formulation.

13. The formulation of claim 11, wherein said Morinda citrifolia product is comprised of one or more of the following: Morinda citrifolia fruit juice, Morinda citrifolia oil extract, Morinda citrifolia dietary fiber, Morinda citrifolia puree juice, Morinda citrifolia puree, Morinda citrifolia fruit juice concentrate, Morinda citrifolia puree juice concentrate.

14. The formulation of claim 11, further comprising one of quercetin and rutin.

15. The formulation of claim 14, wherein said one of quercetin and rutin is present in an amount between 0.01 and 10% by weight.

16. An organic formulation which may be utilized to increase shelf life of various meat products comprising:
at least one processed Morinda citrifolia product present in an amount between about 0.01 and 99.99 percent by weight of the formulation.

17. The formulation of claim 16, comprising an additional ingredient present in an amount between about 0.01 and 10 percent by weight of the formulation.

18. The formulation of claim 16, wherein said Morinda citrifolia product is comprised of one or more of the following: Morinda citrifolia fruit juice, Morinda citrifolia oil extract, Morinda citrifolia dietary fiber, Morinda citrifolia puree juice, Morinda citrifolia puree, Morinda citrifolia fruit juice concentrate, Morinda citrifolia puree juice concentrate.

19. The formulation of claim 16, further comprising quercetin.

20. The formulation of claim 19, wherein said quercetin is present in an amount between 0.01 and 10% by weight.

21. The formulation of claim 16, further comprising rutin.

22. The formulation of claim 21, wherein said rutin is present in an amount between 0.01 and 10% by weight.
